(19) United States
(12) Patent Application Publication
(10) Pub. No.: US 2008/0080730 A1
(43) Pub. Date: Apr. 3, 2008

(54) Electronic Device and Speaker Control Method

(75) Inventor: Masahiko Takakusaki, Fussa-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/848,133

(22) Filed: Aug. 30, 2007

(30) Foreign Application Priority Data
Sep. 28, 2006 (JP) 2006-265845

(51) Int. Cl. H04R 5/02

(52) U.S. Cl. 381/300; 381/28

(57) ABSTRACT

According to one embodiment, an electronic device includes a built-in speaker unit, a first amplifier which drives the built-in speaker unit, a first output circuit which outputs, to the first amplifier, an audio signal in a first frequency range, a second amplifier which drives the detachable speaker unit, a plurality of output circuits each outputting an audio signal in a different frequency range, and a selecting unit which, when the detachable speaker unit is attached to the electronic device, obtains information representing characteristics of the detachable speaker unit from the detachable speaker unit, and, based on the information, selects one of the output circuits to output the audio signal to the second amplifier.

### CROSS-REFERENCE TO RELATED APPLICATIONS

This application is based upon and claims the benefit of priority from Japanese Patent Application No. 2006-265845, filed Sep. 28, 2006, the entire contents of which are incorporated herein by reference.

### BACKGROUND

1. Field

One embodiment of the invention relates to an electronic device including a speaker and a speaker control method used in the electronic device.

2. Description of the Related Art

Recently, there is a tendency that electronic devices, such as personal computers, are required to include AV (audio-visual) functions similar to those of AV equipment. For example, it is requested to improve the quality of sound reproduced by electronic devices. More specifically, there is a demand for rich sound when enjoying music or movies by an electronic device, and for powerful sound when playing games by using the electronic device. In other words, there is a demand to vary the output characteristics of a speaker of an electronic device in accordance with usage.

In light of such demands, various electronic devices have been developed, such as an electronic device including a plurality of speakers, and an electronic device allowing installation of an external speaker. For example, Japanese Patent Application KOKAI Publication No. 2006-106821 discloses an information terminal which includes: a main body having a main computing unit integral with a keyboard; and a display unit attachable to/detachable from a side of the main body via a signal terminal. The signal terminal of the information terminal is configured to be connectable to an external speaker unit when the display unit is detached from the main body.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1A is an exemplary perspective view of an electronic device according to an embodiment of the invention;

FIG. 1B is an exemplary perspective view of the electronic device shown in FIG. 1 in an exemplary state where detachable speaker units are detached from the electronic device;

FIG. 2 is an exemplary schematic diagram showing an exemplary configuration of a speaker unit which can be attached to/detached from the electronic device shown in FIG. 1;

FIG. 3 is an exemplary block diagram showing an exemplary system configuration of the electronic device shown in FIG. 1;

FIG. 4 is an exemplary block diagram for explaining an exemplary connection relationship between a detachable speaker unit and the electronic device shown in FIG. 1; and

FIG. 5 is an exemplary flowchart for explaining a speaker control method according to an embodiment of the invention.

### DETAILED DESCRIPTION

Various embodiments according to the invention will be described hereinafter with reference to the accompanying drawings. In general, according to one embodiment of the invention, there is provided an electronic device to which a detachable speaker can be attached, the electronic device including: a built-in speaker unit; a first amplifier which drives the built-in speaker unit; a first output circuit which outputs, to the first amplifier, an audio signal in a first frequency range; a second amplifier which drives the detachable speaker unit; a plurality of output circuits which output audio signals, each of the output circuits outputting an audio signal in a different frequency range; and a selecting unit which, when the detachable speaker unit is attached to the electronic device, obtains information representing characteristics of the detachable speaker unit from the detachable speaker unit, and, based on the information, selects one of the output circuits to output the audio signal to the second amplifier.

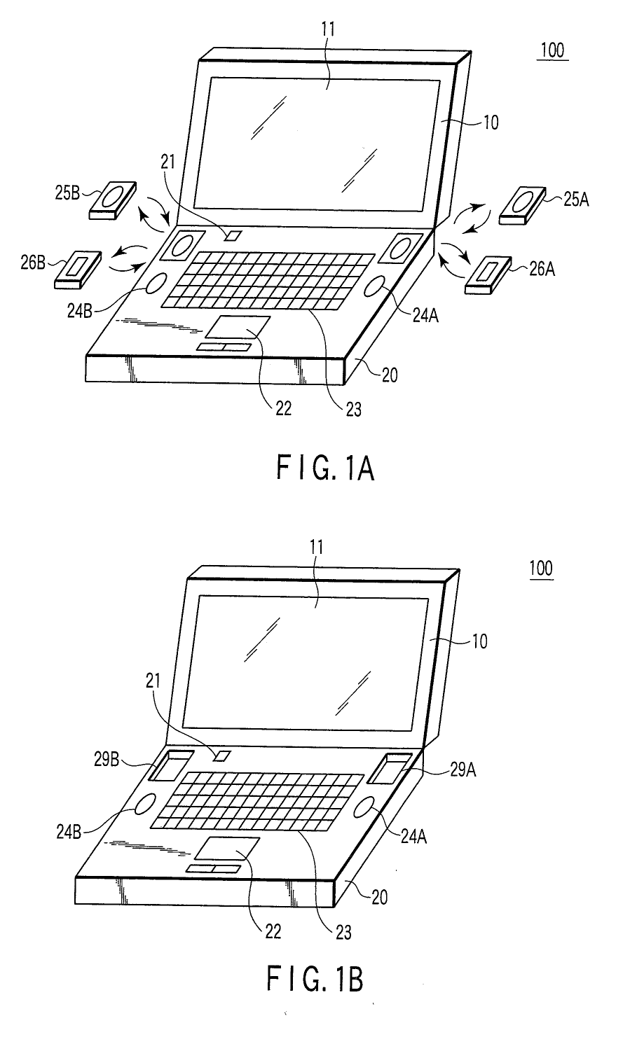

Referring to FIGS. 1A and 1B, a description is given of an electronic device according to an embodiment of the invention. The electronic device may be an arbitrary portable electronic device with a speaker, such as a notebook personal computer and a portable DVD player. For convenience of explanation, a description is given herein by assuming that the portable electronic device is a notebook personal computer (hereinafter referred to as “the notebook PC”) 100.

FIG. 1A is an exemplary perspective view of the notebook PC 100 in a state where a display unit 10 is opened. The notebook PC 100 includes the display unit 10 and a main body 20. The display unit 10 is provided with a display portion 11, which is formed by a liquid crystal display (LCD). The main body 20 includes a power switch 21, a touch pad 22, a keyboard (KB) 23, and built-in speaker units (undetachable speaker units) 24A and 24B.

Additionally, it is possible to attach detachable speaker units (external speaker units) to the notebook PC 100. FIG. 1A shows a pair of detachable speaker units 25A and 25B for high-frequency sound, and a pair of detachable speaker units 26A and 26B for middle/low-frequency sound, and each pair of the speaker units can be attached to the notebook PC 100. It should be noted that FIG. 1A shows an exemplary state where the detachable speaker units 25A and 25B for high-frequency sound are attached to the notebook PC 100.

FIG. 1B shows an exemplary state where the detachable speaker units 25A and 25B are detached from the notebook PC 100 shown in FIG. 1A. As shown in FIG. 1B, the main body 20 of the notebook PC 100 is provided with speaker receiving units 29A and 29B for receiving the speaker units (25A and 25B, or 26A and 26B) in a detachable manner. Each of the speaker receiving units 29A and 29B is formed into a shape which can receive the detachable speaker unit (25A, 25B, 26A, 26B) in the main body 20 of the notebook PC 100. Each of the speaker receiving units 29A and 29B is formed by, for example, a recess provided in a surface of the main body 20. Each of the speaker receiving units 29A and 29B is configured such that, when the detachable speaker unit is received therein, the received speaker unit can be connected to the notebook PC 100.

One pair of detachable speaker units (25A and 25B, or 26A and 26B) are received in the speaker receiving units 29A and 29B, respectively, and are connected to the notebook PC 100. The built-in speaker units 24A and 24B are also housed in the main body 20 of the notebook PC 100. In FIG. 1B, the main body 20 of the notebook PC 100 is provided with the speaker receiving units 29A and 29B and the built-in speaker units 24A and 24B. However, the speaker receiving units 29A and 29B and the built-in speaker units 24A and 24B may be provided in arbitrary portions of a housing (the main body 20, or the display unit 10) of the notebook PC 100. For example, the speaker receiving units 29A and 29B and the built-in speaker units 24A and 24B may be provided in the display unit 10 of the notebook PC 100. Alternatively, the speaker receiving units 29A and 29B may be provided in the display unit 10 of the notebook PC 100, and the built-in speaker units 24A and 24B may be provided in the main body 20 of the notebook PC 100.

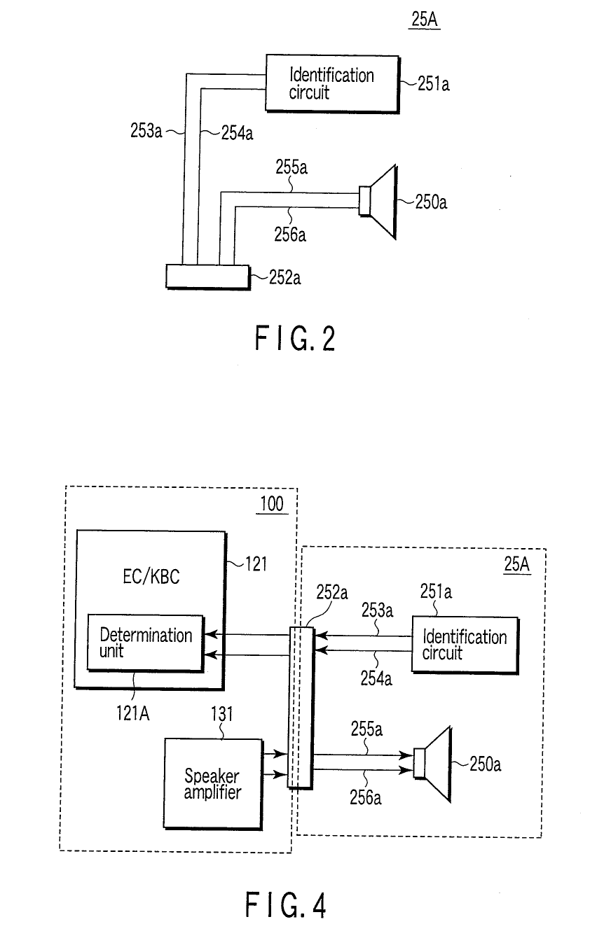

Referring to FIG. 2, a description is given of an exemplary configuration of each of the detachable speaker units (external speaker units) 25A, 25B, 26A and 26B.

FIG. 2 is an exemplary schematic diagram showing an exemplary configuration of the detachable speaker unit 25A which can be attached to/detached from the notebook PC 100. The detachable speaker unit 25A includes a speaker 250a, an identification circuit 251a, and a connector 252a. The speaker 250a and the connector 252a are connected to each other via two audio signal lines 255a and 256a. The identification circuit 251a and the connector 252a are connected to each other via two signal lines 253a and 254a. The notebook PC 100 can obtain, from the detachable speaker unit 25A, information representing the characteristics of the speaker unit 25A via the signal lines 253a and 254a. Each of the other detachable speaker units 25B, 26A and 26B also includes a configuration similar to that of the detachable speaker unit 25A. For example, the detachable speaker unit 25B includes a speaker 250b, an identification circuit 251b, and a connector 252b.

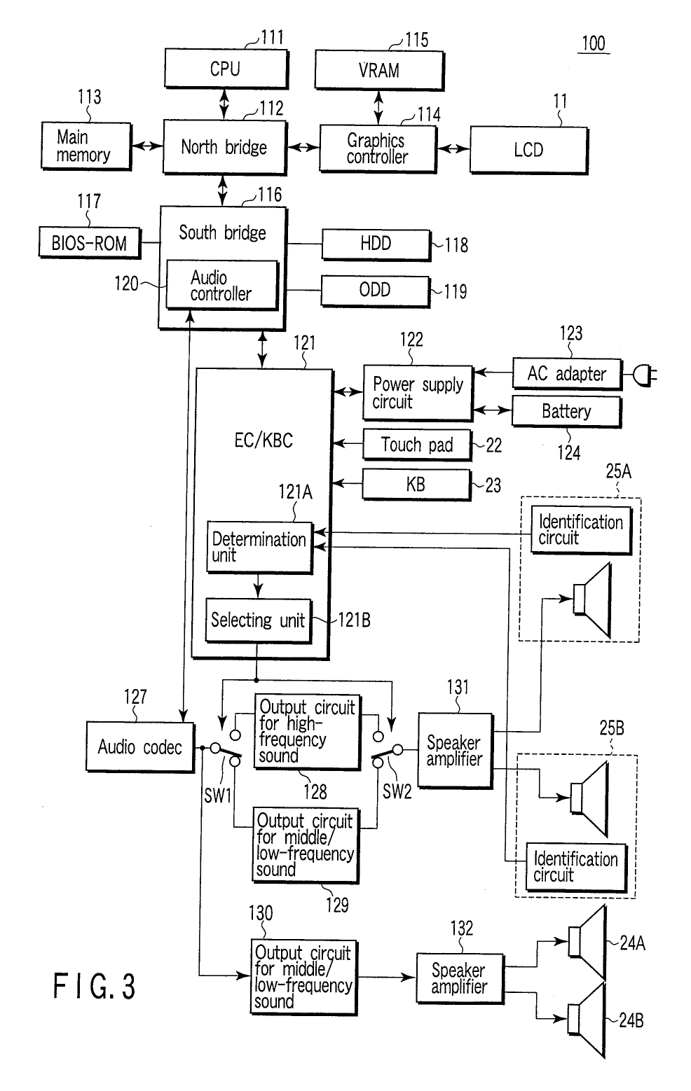

Referring to FIG. 3, a description is given of an exemplary system configuration of the notebook PC 100.

FIG. 3 is an exemplary block diagram showing an exemplary system configuration of the notebook PC 100. As shown in FIG. 3, the notebook PC 100 includes the liquid crystal display (LCD) 10, the touch pad 22, the keyboard (KB) 23, a CPU 111, a north bridge 112, a main memory 113, a graphics controller 114, a video memory (VRAM) 115, a south bridge 116, a BIOS-ROM 117, a hard disk drive (HDD) 118, an optical disk drive (ODD) 119, an audio controller 120, an embedded controller/keyboard controller IC (EC/KBC) 121, a power supply circuit 122, an AC adapter 123, a battery 124, an audio codec (coder-decoder) 127, an output circuit 128 for high-frequency sound, an output circuit 129 for middle/low-frequency sound, an output circuit (audio output circuit) 130 for middle/low-frequency sound, switching circuits SW1 and SW2, speaker amplifiers 131 and 132, the built-in speaker units 24A and 24B, etc. It should be noted that FIG. 3 shows an exemplary state where the detachable speaker units 25A and 25B are attached to the notebook PC 100.

The CPU 111 is a processor which controls an operation of the notebook PC 100. The CPU 111 executes an operating system (OS) and various kinds of application programs which are loaded from the hard disk drive (HDD) 118 to the main memory 113. Additionally, the CPU 111 also executes a BIOS (Basic Input/Output System) stored in the BIOS-ROM 117. The BIOS is a program for controlling peripheral devices, and is initially executed when the notebook PC 100 is turned ON.

The north bridge 112 is a bridge device connecting a local bus of the CPU 111 to the south bridge 116. The north bridge 112 includes a function of performing communication with the graphics controller 114 via, for example, an AGP (Accelerated Graphics Port) bus. The graphics controller 114 is a display controller controlling the liquid crystal display 10 of the notebook PC 100. The graphics controller 114 generates a display signal to be output to the liquid crystal display 10 from display data which are written to the VRAM 115 by the OS or the application programs.

The south bridge 116 is connected to the BIOS-ROM 117, the HDD 118, the ODD 119, the audio codec 127, and the EC/KBC 121. Additionally, the south bridge 116 incorporates therein an IDE (Integrated Drive Electronics) controller for controlling the HDD 118 and the ODD 119. Further, the south bridge 116 incorporates therein an audio controller 120 for generating an audio signal. The audio signal output from the audio controller 120 is converted from a digital signal format to an analog signal format by the audio codec 127. The converted audio signal is output to the speaker amplifier 131 via one of the output circuit 128 for high-frequency sound and the output circuit 129 for middle/low-frequency sound. In addition, the converted audio signal is output to the speaker amplifier 132 via the output circuit 130 for middle/low-frequency sound.

The EC/KBC 121 is a one-chip microcomputer where an embedded controller (EC) for power management and a keyboard controller (KBC) for controlling the touch pad 22 and the keyboard (KB) 23 are integrated. When the power switch 21 shown in FIG. 1 is operated, the EC/KBC 121 turns ON the notebook PC 100 in combination with the power supply circuit 122. When external power is supplied via the AC adapter 123, the notebook PC 100 is driven by the external power. When the external power is not supplied, the notebook PC 100 is driven by the battery 124.

The EC/KBC 121 includes a determination unit 121A which, when the detachable speaker unit is attached to the notebook PC 100, obtains information representing the characteristics of the attached speaker unit from the identification circuit of the attached speaker unit, and determines the characteristics of the attached speaker unit based on the obtained information. Additionally, the EC/KBC 121 includes a selecting unit 121B which selects one of the output circuit 128 for high-frequency sound and the output circuit 129 for middle/low-frequency sound depending on the determination result of the determination unit 121A. In FIG. 3, the determination unit 121A and the selecting unit 121B are shown as separate units. However, the determination 121A and the selecting unit 121B may form a selecting unit.

The output circuit 128 for high-frequency sound, the output circuit 129 for middle/low-frequency sound, and the switching circuits SW1 and SW2 function as an audio output circuit which selectively outputs an audio signal in a high-frequency range and an audio signal in a middle/low-frequency range to the detachable speaker units. For example, in the case where the detachable speaker units 25A and 25 for high-frequency sound are attached to the speaker receiving units 29A and 29B of the notebook PC 100, respectively, the determination unit 121A obtains information representing the characteristics of the detachable speaker units 25A and 25B from the identification circuits 251a and 251b, respectively, and determines the characteristics of the detachable speaker units 25A and 25B. In this case, the determination unit 121A determines that the attached speaker units 25A and 25B are speaker units for high-frequency sound. Based on the determination result of the determination unit 121A, the selecting unit 121B outputs, to the switching circuits SW1 and SW2, selection signals for selecting the output circuit 128 for high-frequency sound as the output circuit to be used. As a result, an input of the output circuit 128 is connected to the audio codec 127 via the switching circuit SW1, and an output of the output circuit 128 is connected to the speaker amplifier 131 via the switching circuit SW2.

On the other hand, in the case where the speaker units 26A and 26B for middle/low-frequency sound are attached to the notebook PC 100, the determination unit 121A obtains information representing the characteristics of the attached speaker units 26A and 26B from respective identification circuits of the speaker units 26A and 26B, and determines the characteristics of the attached speaker units 26A and 26B. In this case, the determination unit 121A determines that the attached speaker units 26A and 26B are speaker units for middle/low-frequency sound. Based on the determination result of the determination unit 121A, the selecting unit 121B outputs, to the switching circuits SW1 and SW2, selection signals for selecting the output circuit 129 for middle/low-frequency sound as the output circuit to be used. As a result, an input of the output circuit 129 is connected to the audio codec 127 via the switching circuit SW1, and an output of the output circuit 129 is connected to the speaker amplifier 131 via the switching circuit SW2.

The output circuit 128 for high-frequency sound includes, for example, a high-pass filter (HPF). The high-pass filter is a filter circuit which extracts a high-frequency component from the audio signal to be reproduced. A cutoff frequency higher than a frequency range (e.g., several kilohertz) corresponding to a middle/low-frequency sound is assigned to the high-pass filter, and the high-pass filter limits the frequency of the audio signal to be reproduced to a frequency range corresponding to high-frequency sound which is higher than the cutoff frequency. The audio signal whose frequency range is limited by the output circuit 128 is output to the speaker amplifier 131.

Each of the output circuits 129 and 130 for middle/low-frequency sound includes, for example, a band-pass filter (BPF). The band-pass filter is a filter circuit which limits the frequency of an audio signal to be reproduced to a frequency range (e.g., several kilohertz) corresponding to a middle/low-frequency sound. The audio signal whose frequency range is limited by the output circuit 129 is output to the speaker amplifier 131. Additionally, the audio signal whose frequency range is limited by the output circuit 130 is output to the speaker amplifier 132.

The speaker amplifier 131 is an amplifier which drives the external speaker units (25A and 25B, or 26A and 26B) attached to the notebook PC 100. The speaker amplifier 131 amplifies audio signals received from the output circuit 128 for high-frequency sound or the output circuit 129 for middle/low-frequency sound, and generates signals for driving the speaker units attached to the speaker receiving units 29A and 29B of the notebook PC 100.

The speaker amplifier 132 is an amplifier which drives the built-in speaker units 24A and 24B. The speaker amplifier 132 amplifies audio signals received from the output circuit 130 for middle/low-frequency sound, and generates signals for driving the built-in speaker units 24A and 24B.

Referring to FIG. 4, a more detailed description is given of an exemplary connection relationship between the notebook PC 100 and the detachable speaker unit (25A, 25B, 26A, 26B).

FIG. 4 is an exemplary block diagram for explaining an exemplary connection relationship between the notebook PC 100 and the detachable speaker unit 25A in the case where the detachable speaker unit 25A is attached to the speaker receiving unit 29A (see FIG. 1B) of the notebook PC 100. It should be noted that FIG. 4 shows only a part of the elements of the notebook PC 100, i.e., the EC/KBC 121, the determination unit 121A and the speaker amplifier 131, for convenience of explanation, and the other elements are omitted.

As shown in FIG. 4, in the case where the detachable speaker unit 25A is attached to the speaker receiving unit 29A (see FIG. 1B) of the notebook PC 100, the identification circuit 251a of the detachable speaker unit 25A and the determination unit 121A of the EC/KBC 121 are connected to each other via the signal lines 253a and 254a. In addition, the speaker 250a of the detachable speaker unit 25A and the speaker amplifier 131 of the notebook PC 100 are connected to each other via the signal lines 255a and 256a.

For example, it is possible to assign a bit (0, 1) to each of the two signal lines 253a and 254a. In this case, the determination unit 121A of the EC/KBC 121 can obtain bit data (e.g., “00”, “01”, “10”) formed by the two signal lines 253a and 254a, and can determine the characteristics of the detachable speaker unit 25A based on the obtained bit data. More specifically, in the case where the bit data obtained form the attached speaker unit is “01”, the determination unit 121A of the EC/KBC 121 may determine that the speaker unit is a speaker unit for high-frequency sound. In the case where the obtained bit data is “10”, the determination unit 121A may determine that the speaker unit is a speaker unit for middle/low-frequency sound. Depending on the determination result of the determination unit 121A, the selecting unit 121B of the EC/KBC 121 selects one of the output circuit 128 for high-frequency sound and the output circuit 129 for middle/low-frequency sound as mentioned above.

Each of the other detachable speaker units 25B, 26A and 26B is connected to the notebook PC 100 in a manner similar to that of the detachable speaker unit 25A.

According to the electronic device (notebook PC 100) of the above-mentioned embodiment, in the case where the detachable speaker units are attached to the electronic device, it is possible to automatically vary the audio output characteristics of the electronic device in accordance with the attached speaker units.

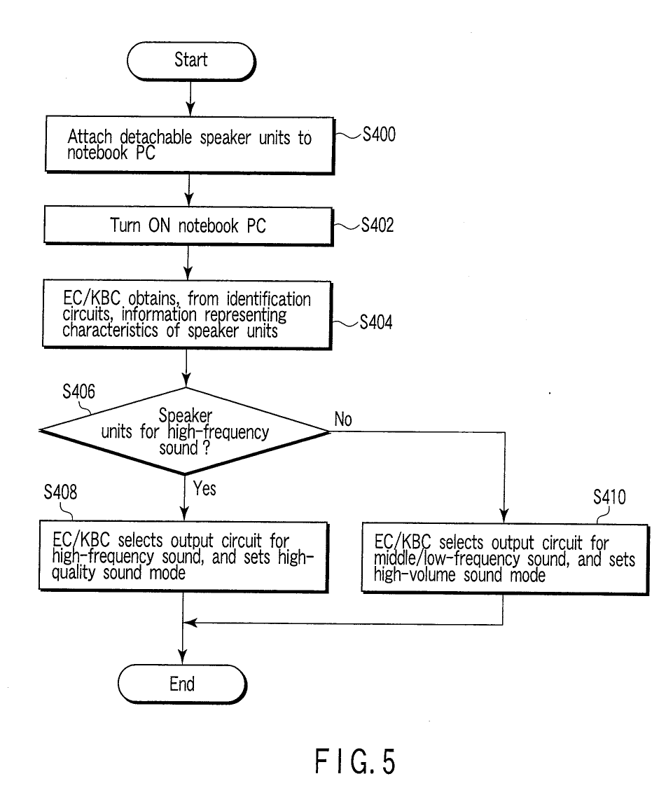

Referring to FIG. 5, a description is given of a speaker control method according to an embodiment of the invention.

FIG. 5 is an exemplary flowchart for explaining a speaker control method according to an embodiment of the invention. The speaker control method can be applied to an arbitrary electronic device including a speaker. Hereinafter, a description is given of an exemplary case where the speaker control method according to this embodiment is applied to the above-mentioned notebook PC 100.

A user attaches the pair of detachable speaker units (25A and 25B, or 26A and 26B) to the speaker receiving units 29A and 29B of the notebook PC 100, respectively (block S400). The user turns ON the notebook PC 100 (block S402). When the notebook PC 100 is turned ON, the determination unit 121A of the EC/KBC 121 obtains information (e.g., bit data “00”, “01”, “10”) representing the characteristics of the attached speaker units from the identification circuits of the attached speaker units (block S404). Based on the obtained information, the determination unit 121A of the EC/KBC 121 determines the characteristics of the attached speaker units (e.g., whether or not the attached speaker units are speaker units for high-frequency sound) (block S406).

When it is determined that the attached speaker units are speaker units for high-frequency sound (YES in block S406), the selecting unit 121B of the EC/KBC 121 selects the output circuit 128 for high-frequency sound as the output circuit to be used, and sets an audio output mode (output characteristics) of the notebook PC 100 to a high-quality sound mode (block S408). The high-quality sound mode is a mode where the sound corresponding to the audio signal to be reproduced is output with a high quality. The high-quality sound mode is suitable for, for example, reproduction of high-quality audio data such as DVD Audio. In the high-quality sound mode, a high-frequency component of the audio signal to be reproduced is output the speaker units for high-frequency sound via the output circuit 128, and a middle/low-frequency component of the audio signal is output to the built-in speaker units via the output circuit 130. Accordingly, in the case where the user attaches the pair of speaker units 25A and 25B for high-frequency sound to the speaker receiving units 29A and 29B, it is possible to reproduce audio data, such as DVD Audio, with a high quality by the built-in speaker units 24A and 24B for middle/low-frequency sound and the speaker units 25A and 25B for high-frequency sound.

On the other hand, when it is determined that the attached speaker units are speaker units for middle/low-frequency sound (NO in block S406), the selecting unit 121B of the EC/KBC 121 selects the output circuit 129 for middle/low-frequency sound as the output circuit to be used, and sets the audio output mode (output characteristics) of the notebook PC 100 to a high-volume sound mode (block S410). The high-volume sound mode is a mode where the sound corresponding to the audio signal to be reproduced is output at a large volume. The high-volume sound mode is suitable for, for example, outputting sound such as sound effects of games with a powerful, large volume. In the high-volume sound mode, each of the speaker units for middle/low-frequency sound and the built-in speaker units is driven by an audio signal for middle/low-frequency sound.

It should be noted that the process of blocks S400 through S410 shown in FIG. 4 is not limited to the above-mentioned order. For example, after the notebook PC 100 is turned ON (block S402), the detachable speaker units may be attached to the notebook PC 100 (block S400), and the determination unit 121A of the EC/KBC 121 may obtain the above-mentioned information from the identification circuits of the attached speaker units (block S404).

According to the speaker control method of the above-mentioned embodiment, in the case where the detachable speaker units are attached to the electronic device (notebook PC 100), it is possible to automatically vary the audio output characteristics of the electronic device in accordance with the characteristics (frequency characteristics) of the attached speaker units.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic device to which a detachable speaker can be attached, the electronic device comprising:
a built-in speaker unit;
a first amplifier configured to drive the built-in speaker unit;
a first output circuit configured to output an audio signal in a first frequency range to the first amplifier;
a second amplifier configured to drive the detachable speaker unit;
a plurality of additional output circuits configured to output audio signals, each of the additional output circuits configured to output an audio signal in a different frequency range; and
a determination unit configured to obtain information representing characteristics of the detachable speaker unit from the detachable speaker unit when the detachable speaker unit is attached to the electronic device; and a selecting unit configured to select, based on the information, one of the additional output circuits to output the audio signal to the second amplifier.

2. The electronic device according to claim 1, wherein the determination unit is configured to determine the characteristics of the detachable speaker unit based on the information, and wherein the selecting unit selects the one of the additional output circuits depending on the characteristics determined by the determination unit.

3. The electronic device according to claim 2, wherein, when the detachable speaker unit is attached to the electronic device, the determination unit is connected to an identification circuit of the detachable speaker unit via a signal line and the second amplifier is connected to a speaker of the detachable speaker unit via an audio signal line.

4. The electronic device according to claim 3, wherein the determination unit is configured to obtain the information from the identification circuit via the signal line.

5. The electronic device according to claim 2, wherein the determination unit is configured to obtain the information when the electronic device is turned ON.

6. The electronic device according to claim 2, wherein the determination unit is configured to obtain the information when the detachable speaker unit is attached to the electronic device after the electronic device is turned ON.

7. The electronic device according to claim 1, wherein the additional output circuits comprise:
a second output circuit configured to output an audio signal in a second frequency range; and
a third output circuit configured to output an audio signal in a third frequency range;
wherein each of the first frequency range and the second frequency range is a frequency range corresponding to a middle/low-frequency sound, and wherein the third frequency range is a frequency range corresponding to a high-frequency sound.

8. The electronic device according to claim 7, wherein the selecting unit is configured to select the third output circuit when the determination unit determines that the detachable speaker unit is a speaker unit for high-frequency sound, and wherein the selecting unit is configured to select the second output circuit when the determination unit determines that the detachable speaker unit is a speaker unit for middle/low-frequency sound.

9. The electronic device according to claim 7, wherein the second output circuit comprises a band-pass filter and the third output circuit comprises a high-pass filter.

10. The electronic device according to claim 1, further comprising:
a speaker receiving unit configured to receive the detachable speaker unit.

11. An electronic device, comprising:
a housing;
a first speaker unit for middle/low-frequency sound provided in the housing;
a first audio output circuit which is provided in the housing and is configured to output, to the first speaker unit, a first audio signal in a first frequency range corresponding to a middle/low-frequency sound;
a speaker receiving unit which is provided in the housing and is configured to receive a second speaker unit in a detachable manner;
a determination unit which is provided in the housing and configured to receive an identification signal representing characteristics of the second speaker unit from the second speaker unit and to determine, when the second speaker unit is received in the speaker receiving unit, whether the second speaker unit is a speaker unit for middle/low-frequency sound or a speaker unit for high-frequency sound depending on the identification signal; and
a second audio output circuit which is provided in the housing and configured to output the first audio signal in the first frequency range to the second speaker unit when the determination unit determines that the second speaker unit is for middle/low-frequency sound, the second audio output circuit further configured to output a second audio signal in a second frequency range to the second speaker unit when the determination unit determines that the second speaker unit is for high-frequency sound, the second frequency range being higher than the first frequency range.

12. A speaker control method applicable to an electronic device to which a detachable speaker unit can be attached, the electronic device including a built-in speaker unit, a first amplifier configured to drive the built-in speaker unit, a first output circuit configured to output an audio signal in a first frequency range to the first amplifier, a second amplifier configured to drive the detachable speaker unit, and a plurality of additional output circuits each configured to output an audio signal in a different frequency range, the speaker control method comprising:
obtaining, when the detachable speaker unit is attached to the electronic device, information representing characteristics of the detachable speaker unit from the detachable speaker unit; and
selecting, based on the information, one of the additional output circuits to output the audio signal to the second amplifier.

13. The speaker control method according to claim 12, further comprising:
determining the characteristics of the detachable speaker unit based on the information; and
wherein selecting one of the additional output circuits comprises:
selecting one of the additional output circuits depending on the determined characteristics.

14. The speaker control method according to claim 13, wherein the additional output circuits comprise a second output circuit configured to output an audio signal in a second frequency range and a third output circuit configured to output an audio signal in a third frequency range, and wherein each of the first frequency range and the second frequency range is a frequency range corresponding to a middle/low-frequency sound and the third frequency range is a frequency range corresponding to a high-frequency sound.

15. The speaker control method according to claim 14, wherein selecting one of the additional output circuits comprises:
selecting the third output circuit when it is determined that the detachable speaker unit is a speaker unit for high-frequency sound, and
selecting the second output circuit when it is determined that the detachable speaker unit is a speaker unit for middle/low-frequency sound.

16. The speaker control method according to claim 14, wherein the second output circuit comprises a band-pass filter and the third output circuit comprises a high-pass filter.

17. The speaker control method according to claim 12, wherein the additional output circuits comprise a second output circuit configured to output an audio signal in a second frequency range and a third output circuit configured to output an audio signal in a third frequency range, and wherein each of the first frequency range and the second frequency range is a frequency range corresponding to a middle/low-frequency sound and the third frequency range is a frequency range corresponding to a high-frequency sound.

18. The speaker control method according to claim 12, wherein obtaining the information comprises obtaining the information from an identification circuit of the detachable speaker unit.
